(19) United States
(12) Patent Application Publication
(10) Pub. No.: US 2008/0023257 A1
(43) Pub. Date: Jan. 31, 2008

(54) Steering system

(76) Inventors: Martin Budaker, Heubach (DE); Wolfgang Reuter, Florstadt (DE)

Correspondence Address: JORDAN AND HAMBURG LLP, 122 EAST 42ND STREET, SUITE 4000, NEW YORK, NY, 10168, US

(21) Appl. No.: 11/801,699

(22) Filed: May 10, 2007

Related U.S. Application Data
(63) Continuation of application No. PCT/EP05/55812, filed on Nov. 8, 2005.

(30) Foreign Application Priority Data
Dec. 10, 2004 (DE) 10 2004 059 461.9

(51) Int. Cl. B62D 3/00; B62D 5/04

(52) U.S. Cl. 180/444

(57) ABSTRACT

The invention relates to a steering system, in particular for a motor vehicle, comprising an electric motor (10) for boosting the steering effort and a steering column (11). In the steering effort boosting system known from the state of the art the electric motor together with a transmission transmits a torque to the steering column, the electric motor being arranged perpendicularly to the steering column. This arrangement has a relatively large space requirement. It is the object of the invention to save installation space in future. For this reason, according to the invention, the steering column (11) and the electric motor (10) are arranged parallel to or coaxial with one another.

### DESCRIPTION

The invention relates to a steering system, in particular for a motor vehicle, comprising an electric motor for boosting the steering effort, and a steering column.

As is generally known from the state of the art, in a servo unit integrated in the steering column an electric motor transmits a boosting force by means of a gearbox on the steering column. The torque exerted on the steering column by the electric motor is increased by the gearbox reduction ratio, so that the desired boosting force is transmitted to the steering rack. With an electrically-assisted steering system worm gears, with which a reduction ratio of approximately 1:16 to 1:30 is possible, are almost exclusively used. However, worm gears have the major disadvantage that they are relatively costly, do not remain free of play over the life of the vehicle and have poor efficiency. Moreover, they have a relatively large space requirement, because the electric motor is arranged at right angles to the steering column.

It is the object of the invention to improve the steering system of the type mentioned in the introduction in such a way that its space requirement can be significantly reduced.

The invention achieves this object with a steering system of the type mentioned in the introduction in which, according to the invention, the steering column and the electric motor are arranged parallel to or coaxially with one another. Through this arrangement significant installation space can be saved in future. In addition, this arrangement reduces the risk that the electric motor is pushed into the passenger compartment in the event of an accident. The inventive arrangement therefore contributes to protecting the occupants of the vehicle in an accident.

A motor shaft of the electric motor and the steering column may be connected to one another by at least one belt, in particular by at least one toothed belt. Through the use of one or more belts the relatively costly and space-consuming worm drive can be dispensed with in future. In comparison to worm gears, belt transmissions have superior efficiency. The use of belts therefore saves cost and installation space. Furthermore, the use of belts also contributes to protecting the occupants of the vehicle in an accident, because the worm gearbox can no longer be forced into the interior of the vehicle in an accident. The use of toothed belts makes possible reliable transmission of torque. In addition, toothed belts remain free of play and noise throughout the life of the vehicle.

To achieve a highest possible reduction ratio with the use of belts, at least one further shaft may be arranged in parallel between the motor shaft and the steering column, the at least one further shaft being connected by at least one belt in each case to each of the shafts adjacent to it. In this way a multistep belt transmission can be implemented.

In a multistep belt transmission the belt connected to the electric motor may be a toothed belt with a low modulus and the belt connected to the steering column may be a toothed belt with a high modulus. With the use of a belt with a low modulus, low torques can be transmitted at high revolutions while the noise level is low. If a belt with a high modulus is used, high torques can be transmitted at low revolutions, while the noise level, and the risk-of teeth of the toothed belt jumping over teeth of the belt pulley, are low.

To ensure a reduction ratio, a belt pulley arranged on the motor shaft may have a smaller diameter than the belt pulley arranged on the shaft adjacent to the motor shaft.

Likewise, to achieve a reduction ratio, a belt pulley arranged on the steering column may have a larger diameter than the belt pulley arranged on the shaft adjacent to the steering column.

In a further embodiment, the electric motor and the steering column may be connected to one another by a toothed belt transmission in which the toothed belt is toothed on both sides and the two sides of the toothed belt have different numbers of teeth. With this embodiment, too, the space requirement can be significantly reduced while at the same time extremely high reduction ratios can be achieved.

In a likewise preferred embodiment the electric motor may have a hollow motor shaft which receives the steering column. This embodiment has an especially small space requirement.

In this embodiment, in order to achieve a highest possible reduction ratio, a further shaft, on which are arranged a large and a small belt pulley, may be arranged parallel to the motor shaft and to the steering column, the large belt pulley being connected to a smaller belt pulley on the motor shaft and the small belt pulley being connected to a larger belt pulley on the steering column.

It is especially elegant if a torque sensor is integrated in a large belt pulley arranged on the steering column. The torque sensor can then detect the torque required for steering, so that, depending on the torque determined, the electric motor can generate the required steering effort assistance.

The steering column is advantageously mounted in a steering column housing.

Different embodiments of the inventive steering system are explained in more detail below with reference to the appended drawings, in which:

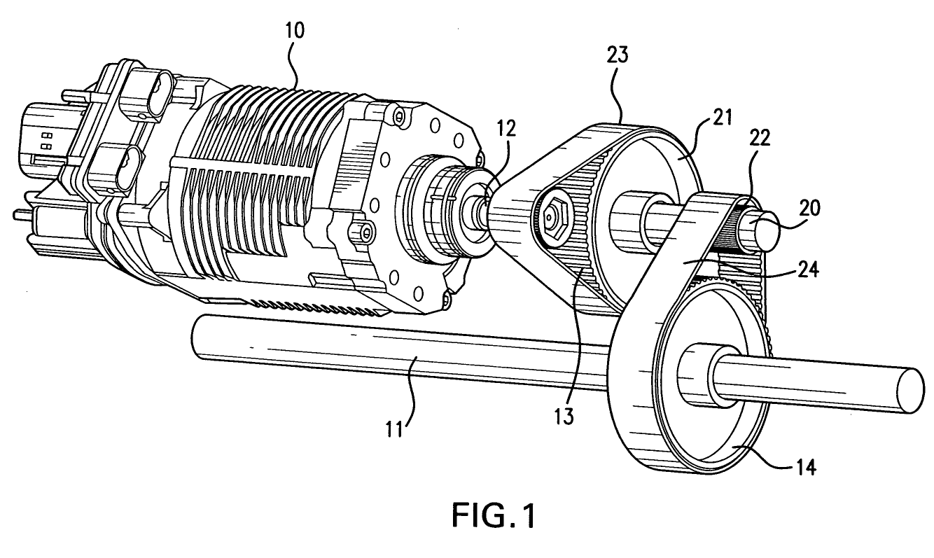

FIG. 1 is a side view of a first embodiment;

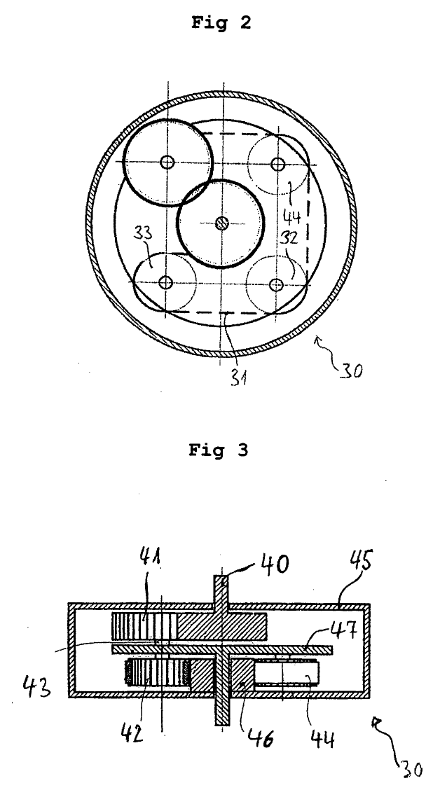

FIG. 2 is a side view of a second embodiment;

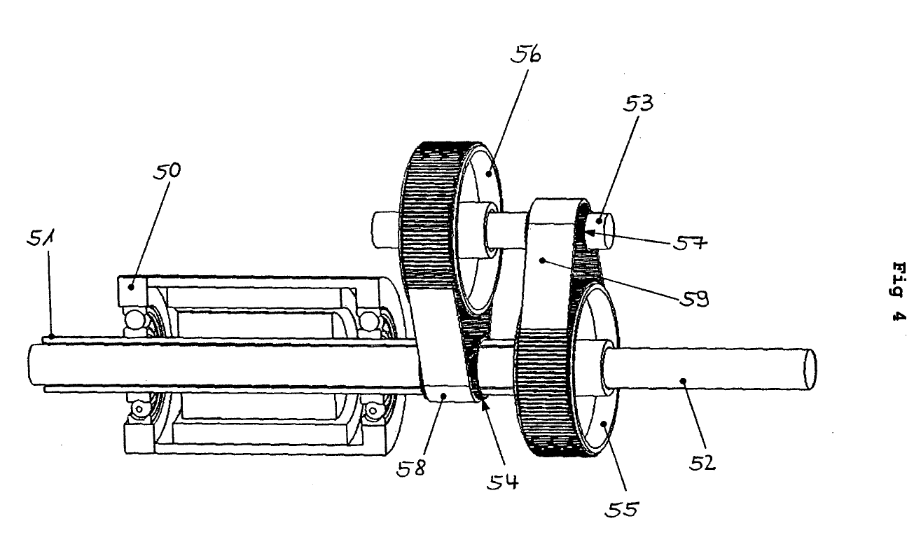

FIG. 3 is a top view of a belt transmission of a third embodiment, comprising a toothed belt toothed on both sides;

FIG. 4 is a sectional view through the toothed belt transmission of FIG. 3;

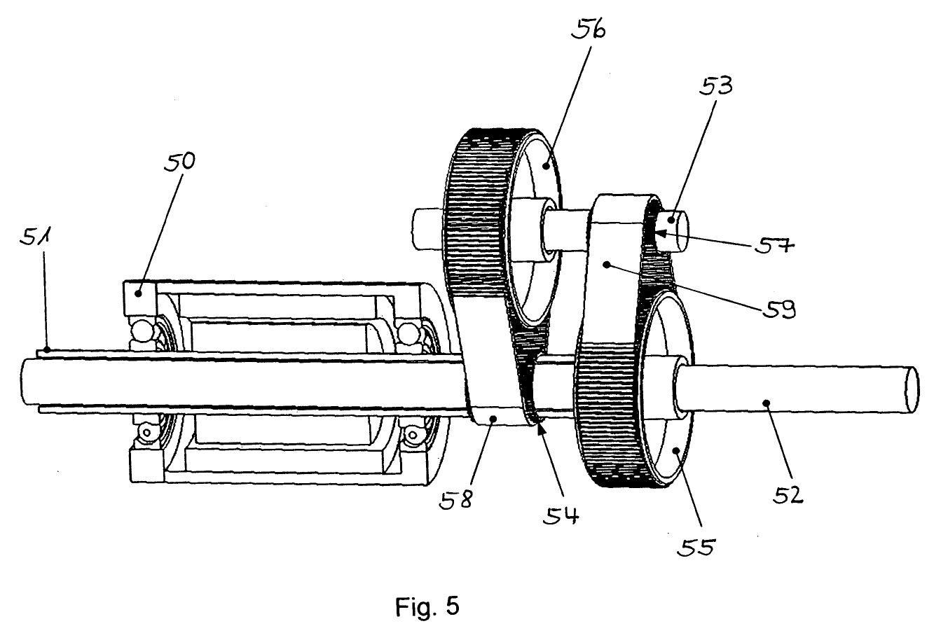

FIG. 5 is a side view of a fourth embodiment.

FIG. 1 shows an electric motor 10 which is arranged parallel to a steering column 11. A small belt pulley 13 is mounted on a motor shaft 12 and a large belt pulley 14 is mounted on the steering column 11. The small belt pulley 13 and the large belt pulley 14 are connected to one another by a toothed belt 15. Through the arrangement of the small belt pulley 13 on the motor shaft 12 and of the large belt pulley 14 on the steering column 11, a gearing-down of the rotational speed of the electric motor 10 is achieved.

FIG. 2 shows the electric motor 10 and the steering column 11, a further shaft 20 being arranged parallel to the motor shaft 12 and to the steering column 11. A larger belt pulley 21 and a small belt pulley 22 are mounted on the further shaft 20. The belt pulley 13 and the larger belt pulley 21 are connected by a toothed belt 23 and the smaller belt pulley 22 and the belt pulley 14 by a toothed belt 24. By means of the further shaft 20 a two-step belt transmission is produced, the diameters of the belt pulleys 13, 21, 22 and 14 being so selected that a largest possible gearing-down of the rotational speed of the electric motor 10 is achieved. Self-evidently, further shafts may also be provided apart from the shaft 20, in order to construct belt transmissions with a higher number of steps and thereby to achieve still larger reductions of the rotational speed of the electric motor 10.

FIG. 3 shows a toothed belt transmission 30 with a toothed belt 31 toothed on both sides, which has a different number of teeth on each side. Very high reduction ratios can be attained in a very small installation space with the toothed belt transmission 30.

In this embodiment a gear wheel 40 is connected to the electric motor (not shown in detail). The torque of the electric motor is transmitted by the gear wheel 40 to a gear wheel 41. The gear wheel 41 is mounted with a belt pulley 42 arranged below it on a common shaft 43, the gear wheel 41 and the belt pulley 42 being rigidly connected to the shaft 43. Consequently, the torque is transmitted by the shaft 43 from the gear wheel 41 to the belt pulley 42. With its internal toothing the toothed belt 31 transmits the torque from the belt pulley 42 to the belt pulleys 44, 32 and 33 (cf. FIGS. 3 and 4). With its external toothing the toothed belt 31 wraps a belt pulley 46 connected rigidly to a housing 45. Through the different number of teeth of the internal toothing and the external toothing of the toothed belt 31, a disk 47 which is connected to the steering column (also not shown) is set in rotary motion, the rotational speed of the disk 47 being significantly lower than that of the gear wheel 40. Consequently, the rotational speed of the electric motor is reduced by the toothed belt transmission 30.

FIG. 5 shows an electric motor 50 which has a hollow motor shaft 51. A steering column 52 is inserted in the hollow motor shaft 51, for which reason this embodiment has an especially small space requirement. A further shaft 53 is provided parallel to the steering column 52. A small belt pulley 54 and a large belt pulley 55 are arranged on the motor shaft 51. A large belt pulley 56, which is connected by a toothed belt 58 to the belt pulley 54, and a small belt pulley 57, which is connected by a toothed belt 59 to the belt pulley 55, are mounted on the further shaft 53. A high reduction ratio can be achieved by means of the selected arrangement of the belt pulleys 54, 55, 56 and 57.

The belt pulleys 55 and 57 are arranged on the shafts 52 and 53 on the right of, the belt pulleys 56 and 58. Through this arrangement a torque sensor (not shown in detail) can be integrated in the steering column 52 in the region of the electric motor 50.

### List of References

10 Electric motor
11 Steering column
12 Motor shaft
13 Belt pulley
14 Belt pulley
15 Toothed belt
20 Further shaft
21 Belt pulley
22 Belt pulley
23 Toothed belt
24 Toothed belt
30 Toothed belt transmission
31 Toothed belt
32 Belt pulley
33 Belt pulley
40 Gear wheel
41 Gear wheel
42 Belt pulley
43 Shaft
44 Belt pulley
45 Housing
46 Belt pulley
47 Disk
50 Electric motor
51 Motor shaft
52 Steering column
53 Further shaft
54 Belt pulley
55 Belt pulley
56 Belt pulley
57 Belt pulley
58 Toothed belt
59 Toothed belt

1. A steering system, in particular for a motor vehicle, comprising an electric motor for boosting the steering effort and a steering column, the steering column and the electric motor being arranged parallel to or coaxial with one another, at least one further shaft arranged in parallel between the motor shaft and the steering column the at least one further shaft being connected by at least one belt in each case to each of the shafts adjacent thereto.

2.-3. (canceled)

4. The steering system as claimed in claim 1, wherein the belt connected to the electric motor is a toothed belt with a low modulus and the belt connected to the steering column is a toothed belt with a high modulus.

5. The steering system as claimed in claim 1, wherein a belt pulley arranged on the motor shaft has a smaller diameter than the belt pulley arranged on the shaft adjacent to the motor shaft.

6. The steering system as claimed in claim 3 , wherein a belt pulley arranged on the steering column has a larger diameter than the belt pulley arranged on the shaft adjacent to the steering column.

7. The steering system as claimed in claim 1, wherein the electric motor and the steering column are connected to one another by a toothed belt transmission, the toothed belt being toothed on both sides and the two sides of the toothed belt having different numbers of teeth.

8. The steering system as claimed in claim 1, wherein the electric motor has a hollow motor shaft which receives the steering column.

9. The steering system as claimed in claim 8, wherein a further shaft, on which a large belt pulley and a small belt pulley are arranged, is arranged parallel to the motor shaft and to the steering column, the large belt pulley being connected to a smaller belt pulley on the motor shaft and the small belt pulley being connected to a larger belt pulley on the steering column.

10. The steering system as claimed claim 1, wherein a torque sensor is arranged in a large belt pulley arranged on the steering column.

11. The steering system as claimed in claim 1, wherein the steering column is mounted in a steering column housing.
